(19) United States
(12) Patent Application Publication
(10) Pub. No.: US 2008/0320453 A1
(43) Pub. Date: Dec. 25, 2008

(54) TYPE INFERENCE AND LATE BINDING

(75) Inventors: Henricus Johannes Maria Meijer, Mercer Island, WA (US); Amanda Silver, Seattle, WA (US); Paul A. Vick, Seattle, WA (US); Jonathan Paul Aneja, Kirkland, WA (US); Timothy Yat Tim Ng, Bellevue, WA (US); John J. Rivard, Redmond, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/766,345

(22) Filed: Jun. 21, 2007

(51) Int. Cl. G06F 9/45

(52) U.S. Cl. 717/140

(57) ABSTRACT

A type inference option is available for a computer programming language. The option acts as a switch to specify whether or not type inference is applicable (e.g., on or off). Type inference can be employed in conjunction with late binding or options therefor. In this manner, a computer program can be developed with the convenience of type inference and the flexibility of late binding while still maintaining at a degree of type safety.

### BACKGROUND

Computer programs are groups of instructions that describe actions to be performed by a computer or other processor-based device. When a computer program is loaded and executed on computer hardware, the computer will behave in a predetermined manner by following the instructions of the computer program. Accordingly, the computer becomes a specialized machine that performs the tasks prescribed by the instructions.

A programmer using one or more programming languages creates the instructions comprising a computer program. Typically, source code is specified or edited by a programmer manually and/or with help of an integrated development environment (IDE). Subsequently, the source code can be compiled or otherwise transformed by another program into computer instructions executable by a computer or like device.

By way of example, a programmer may choose to implemented code utilizing an object-oriented programming language (e.g., C#, Java . . . ). In accordance with such a paradigm, programmers create a number of classes identifying properties and characteristics of an abstract thing as well as methods describing class behavior or abilities. Specific programmatic logic can then be specified as interactions between instances of classes or objects, among other things. Subsequently, executable code for a particular machine can be produced by an associated compiler. Alternatively, code can be transformed into intermediate code for a target virtual machine to facilitate execution on multiple computer platforms via further compilation or interpretation of the intermediate code.

Conventionally, programming languages are either statically typed or dynamically typed. Types provide constraints on the interpretation of data in accordance with a language type system. Accordingly, types can be utilized to detect programming errors via a type checking. In this manner, a degree of program safety can be obtained by detecting meaningless or likely invalid code as a function of data types. This can be accomplished either statically or dynamically. A statically typed language enables a program to be type checked at compile time. Accordingly, all types are known at compile time, for example by explicit specification or type inference. Dynamically typed languages differ in that they are type checked at runtime. As a consequence, types need not be explicitly specified or inferred prior to use, rather they are determined during execution.

When selecting a language, programmers need to consider tradeoffs between static and dynamic typing. In particular, static typing is beneficial in that errors can be detected prior to execution and programs can execute very efficiently. Further, design time experience can be improved since feedback or assistance can be afforded as a function of known types. However, dynamically typed languages allow more programmatic flexibility than static typed languages enabling programmers to specify code would not be allowed based on restrictions of a static type system. Furthermore, dynamically typed languages are easier to use, as programmers need not be concerned with type specification.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to employment of type inference with respect to computer program compilation/translation. More specifically, type inference can be toggled on or off at various levels of granularity (e.g., project, file, programmatic construct, group of constructs . . . ). In one instance, type inference can be controlled as a function of a default and/or explicitly specified type option (e.g., Option Infer On).

In accordance with an aspect of the disclosure, type inference can be employed in combination with late binding. Similar to type inference, binding behavior can switched on and off with an option at various levels of granularity. Type inference and binding options can be independent or dependent of each other. Where both type inference and late binding coexist, types can be inferred for constructs at compile time exclusive of those designated for late binding. In one implementation, late binding can be designated by way of explicit specification of a root type such as “Object.” Subsequently, late binding can be performed.

According to yet another aspect of the disclosure, feedback can be provided to a programmer with respect to option specification. Option designations, including specific options and their status, can be recommended during coding to help programmers determine appropriate options. For example, an option state can be suggested that is likely to produce the least amount of errors given current program state.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a program compiler/translation system for controlling type inference in accordance with an aspect of the claimed subject matter.

FIG. 2 is a block diagram of a program compiler/translation system for controlling type inference and member binding in accordance with an aspect of the claimed subject matter.

FIG. 3 is a block diagram of an exemplary computer program including inference and binding options.

FIG. 4 is a block diagram of an option determination system.

FIG. 5 is a flow chart diagram of a representative method of type inference utilizing options.

FIG. 6 is a flow chart diagram of a representative method of binding utilizing options.

FIG. 7 is a flow chart diagram of a representative method of type inference and binding.

FIG. 8 is a flow chart diagram of a representative method of program analysis.

FIG. 9 is a schematic block diagram illustrating a suitable operating environment for aspects of the subject disclosure.

FIG. 10 is a schematic block diagram of a sample-computing environment.

### DETAILED DESCRIPTION

Systems and methods are described hereinafter with respect to type inference activation, among other things. A computer program can be associated with an inference option that indicates whether or not type inference is to apply to a program or portions thereof. Type inference can also interact in various manners with other program language features or options of a single program language including early/late binding. Still further yet, a program can be analyzed and inference, binding and/or other options recommended or suggested as a function of the analysis to aid programmers in program specification.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

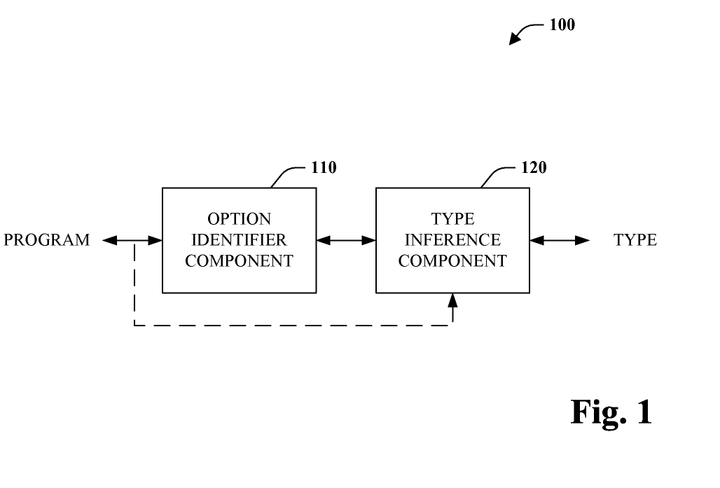

Referring initially to FIG. 1, a program compiler/translation system 100 is illustrated in accordance with an aspect of the claimed subject matter. The compiler/translation system 100 is operable to analyze and transform or translate a program from a first form to a second form. Accordingly, the compiler system 100 can correspond to a source code compiler or a just-in-time (JIT) compiler, among other things. The compiler system 100 includes an option identifier component 110 and a type inference component 120.

The option identifier component 110 locates or otherwise identifies semantic or compiler options associated with a program. The options can be specified at one or more levels of granularity including project, file and/or construct level among others. Further yet, the options can be specified at a compiler command line. Where specified options conflict, the option identifier component 110 can resolve the conflict utilizing predefined rules, inference or other mechanisms. For instance, a project option may override a command line prompt, which may take precedence over a file or construct option, or vice versa.

In accordance with one aspect, the option identifier component 110 can identify a type inference option. Type inference is a convenience mechanism that allows programmers to omit type annotations where the types can subsequently be inferred automatically. Accordingly, the type inference option can act as a switch to turn type inference on or off for a program or portion thereof. By way of example and not limitation, the option can be specified as a statement at the beginning of the file such as “Option Infer On” or “Option Infer Off” Alternatively, it can appear in a command line prompt such as “/optioninfer: +” or “/optioninfer −.” The option identifier component 110 can identify options from one or more of such locations.

The type inference component 120 is a mechanism that performs type inference in accordance with any conventional or novel inference algorithm native to the compiler or extended by a plug-in or the like. The type inference component 120 can receive, retrieve or otherwise obtain or acquire inference option information from the option identifier component 110. If the option indicates that type inference is to be performed, the type inference component 120 can be activated to infer types. Otherwise, the type inference component 120 remains inactive or unemployed. The result of the type inference component 120, if successful, is a type. An inferred type or failure to infer a type can be employed by a type checker component (not shown) to identify programmatic errors as a function of types, among other things.

By way of example, consider a generic variable assignment “x=5.” If type inference were on, then “x” would be inferred to its precise type integer since “5” is an integer and it is assigned to the field/variable “x.” If inference is off, then the type inference is not performed. In a static language would cause an error since the type of “x” was neither declared explicitly as in “Int x=5” or inferred.

It should be appreciated that type inference can be applicable to any or all syntactic and/or semantic constructs. The above example pertains to a local variable and more specifically local variable initialization. However, the claimed subject matter is not so limited. Type inference can also apply to return results and/or parameters, among other things. Furthermore, the granularity of type inference can be explicitly delimited. For example, the inference option can be parameterized or qualified to indicate that type inference is to apply to local variables, returns results and/or method parameters. Dually, type inference can be turned on everywhere except for explicitly listed scenarios and/or constructs. For instance, type inference can be specified as on excluding method parameters—meaning, type inference will not be performed with respect to method parameters but will otherwise apply.

Compiler/translation system 100 is applicable to either static or dynamic languages. Moreover, in accordance with an aspect of the claimed subject matter, type inference functionality provided by system 100 can be implemented with respect to a hybrid static/dynamic language. In other words, the system 100 is applicable to a program including both static features such type inference as well as dynamic features such as late binding.

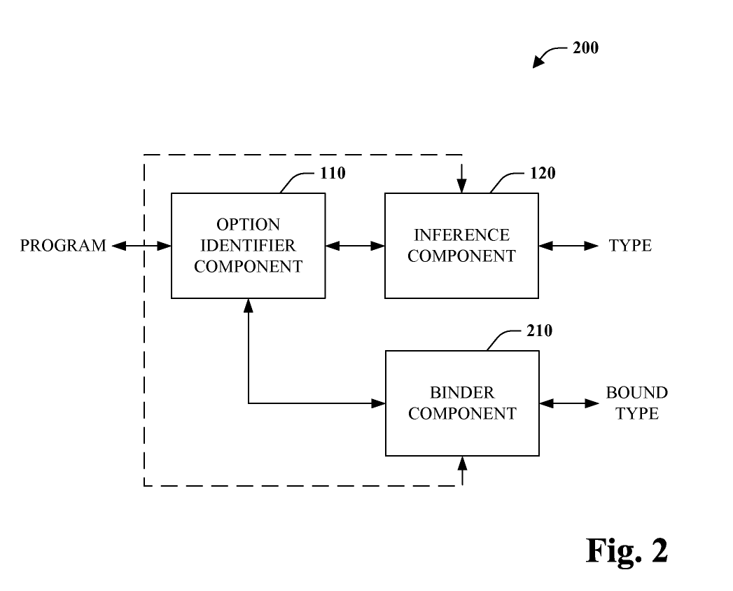

Turning attention to FIG. 2, a program compiler/translation system 200 is illustrated in accordance with an aspect of the claimed subject matter. Similar to system 100 of FIG. 1, the system 200 can include the option identifier component 110 and the inference component 120, as previously described. In brief, the option identifier component 110 locates a semantic and/or compiler option associated with a program that is utilized to switch type inference provided by the component 120 on or off. Additionally, the system 200 includes binding component 210 communicatively coupled to the option identifier component 110.

The binding component 210 binds types to objects, among other things. In object-oriented programming, for instance, objects can include members such as methods, functions and/or fields/variables. One feature of object-oriented programming is polymorphism, which refers to a concept that objects of different types can respond to member calls of the same name each one providing a potentially differing functionality. For example, if class “B” is derived from class “A,” then B need not inherit everything from class A; it can do some things differently. Hence, functionality is determined by a type bound to an object. Additionally or alternatively, the binding component 210 can bind types to generic methods or the like. It is to be appreciated that the binding component 220 can include one or more sub-components (not shown) for looking up types, inferring types and/or resolving overloads, among other things.

The functionality of binding component 210 can be applied early at compile time or late at runtime. Type can be bound to objects at compile time if they are known. However, sometimes types cannot be determined at compile time and/or binding is not desired at that time. In this case, binding can be applied at runtime prior to execution. In any event, the functionality provided by the binding component 210 can be substantially similar whether performed at compile time or runtime.

Applicability of the binding component 210 can be dependent upon an associated option. The option identifier component 110 can identify a binding option (e.g., option strict) that indicates whether binding is to be performed early or late. Similar to the inference option, the binding option can be identified from, among other things, a program/project statement and/or a compilation option. Moreover and in accordance with one aspect, binding can be dependent upon an explicit type. For example, if a variable is explicitly specified of a root type such as “Object,” then late binding is on for that expression. In this manner, programmers can opt into late binding via explicit type annotation.

It is to be appreciated that there can be interdependencies between binding and inference options. For instance, if late binding is turned on (e.g., option strict off) then type inference can be switched off or alternatively if late binding is off (e.g., option strict on), type inference can be turned on. One issue with the example dependencies is that some users may want to have both late binding and type inference on for flexibility and strong typing, respectively. Accordingly, the dependency can be such that when type inference is on, late binding is on or vice versa. Any dependencies can be implemented and effectuated by the option identifier component 110.

By way of example, consider an exemplary static typed code segment “Dim X=3.” If type inference is on for local variables, a compiler could use the variable's initialization to determine its type at compile type. Here, since “3” is an integer, “X” can be inferred as type integer. This could also be considered early bound code as the variable “X” is bound to type integer. Alternatively, if type inference is off, then an error could be generated since type is not explicitly specified.

Consider another exemplary code snippet:

### Dim X=5

X=“abc”
If type inference is turned on, the type can be inferred to be of type object, a common super type of integer and string. However, if type inference is on only for local variable initialization, then an error would be produced. In this case, “X” would be inferred first to be of type integer. Subsequently, an error would be produced with respect to the second line of code, as this would be interpreted as attempting to assign a string “abc” to an integer variable.

Type inference and binding can interact in a myriad of different ways. By way of example, consider a system that requires a global option (e.g., Option Strict Off) and a root type object to indicate late binding is to be applied. Consider the following code snippet:

### Option Infer On

### Option Strict Off

### Dim X=3;

Here, the type of “X” would be inferred to type integer based on the assignment of the integer “3.” Programmers can explicitly opt into late bind by explicitly specifying the type as object as follows:

### Option Infer On

### Option Strict Off

### Dim X As Object=3;

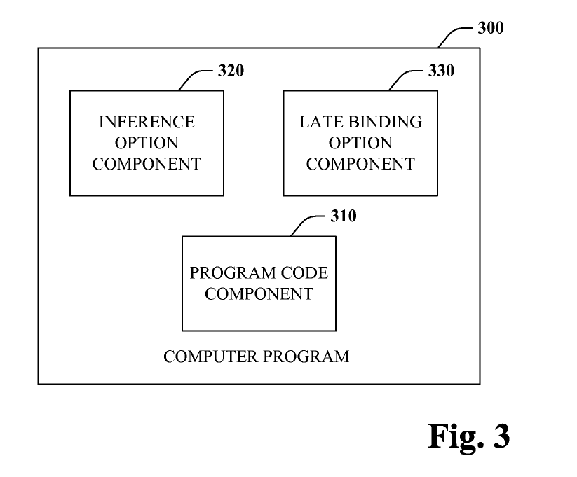

Referring to FIG. 3, an exemplary program 300 is illustrated in accordance with an aspect of the claimed subject matter. The program 300 can be a program file, group of files, or project, among other things. Program code component 310 includes sequence of one or more statements and/or declarations in a computer programming language (e.g., C #, Visual Basic, Java, Intermediate Language Code (IL) . . . ). The program can also include inference option component 320 and binding option component 320 internal and/or external to the program code component 310. For instance, options can be specified within a program file or at a project level.

The inference option component 320 specifies whether or not and/or where type inference is to apply. For example, the component 320 can be implemented as statement such as “Option Infer On/Off.” The statement can also be qualified by inclusion and/or exclusion groups such as “Option Infer On+local variables” or “Option Infer On−method parameters, results,” respectively.

The binding option component 330 indicates whether types are early bound or late bound. Furthermore, the binding options can be specified implicitly or explicitly at varying levels of granularity such as for an entire project or a single expression in a program file. In one instance, the binding option can be implemented as a statement such as “Option Strict On/off,” “Option Late Bind On/Off,” or “Option Early Bind On/Off.” The statement can also be qualified to include or exclude particular constructs or regions of code. Additionally or alternatively, the binding component 330 can include and/or be triggered by an implicit and/or explicit type such as language root type (e.g., Object).

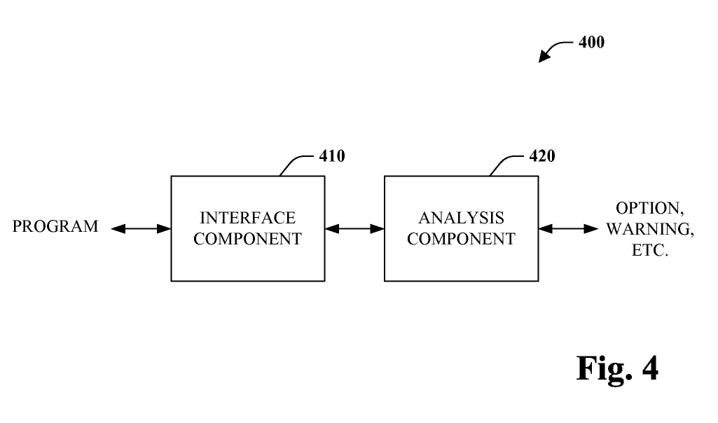

Turning attention to FIG. 4, an option determination system 400 is illustrated in accordance with an aspect of the disclosure. The system 400 provides a mechanism for providing feedback regarding options and their usage. In one implementation, the system 400 can form a part of a program development component or system such as a program editor, tool, integrated development environment (IDE) and/or the like. Accordingly, the system 400 can be a pluggable extension for conventional program development environments.

The option determination system 400 includes an interface component 410 and an analysis component 420. The interface component 420 provides a mechanism for interacting with a program. In one instance, the interface component can receive and/or retrieve program code and transmit or otherwise make the code available to the analysis component 420. Upon acquisition of program code, the analysis component 420 can analyze the code and make suggestions corresponding to semantic or compiler options such as type inference and/or binding options. In essence, the analyzer component 430 can infer options that result in the least amount of errors.

In one implementation, the analysis component 420 can employ control flow analysis to look at types being assigned explicitly or implicitly. Based on this analysis, feedback can be provided to a programmer suggesting type inference be turned on or off. Furthermore, assistance can be provided to change option state. For instance, feedback can be provided as a warning indicating that the system believes the programmer should utilize a particular option and a smart tag that can be activated to change option state.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the inference component 120 can employ such mechanisms to facilitate identification and binding of types. Furthermore, the analysis component 420 can employ machine learning with respect to code analysis and option suggestion.

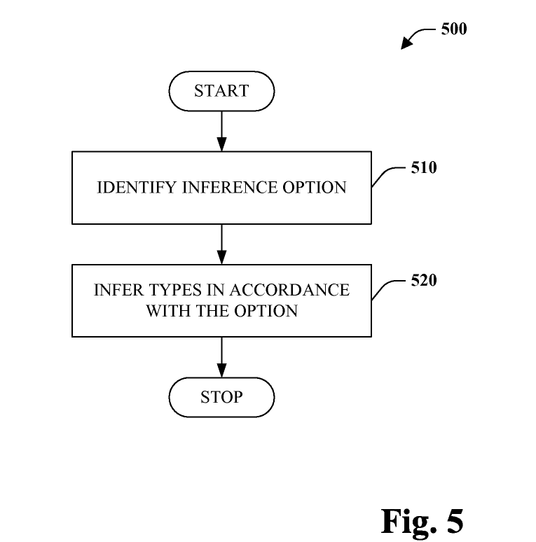

In view of the exemplary systems described sura, methodologies that may be implemented in accordance with the disclosed subject matter will be better appreciated with reference to the flow charts of FIGS. 5-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 5, a type inference method 500 is illustrated in accordance with an aspect of the claimed subject matter. The type inference method 500 automatically supplies omitted types for programmatic constructs where the types can be inferred. At reference numeral 510, an inference option is identified. By way of example and not limitation, the inference option can be identified as an option statement in a program file or project (e.g., “Option Infer On/Off”). Additionally or alternatively, the option can be identified from a compile command prompt, for instance “/optioninfer[+|−].” Still further yet, the option can be inferred or identified as a default. At numeral 520, the type inference is performed in accordance with an identified option. For example, if the type inference option is on, types can be inferred and bound to objects at compile time. Alternatively, no action need be taken. Furthermore, it is to be appreciated that type inference can be applied at various levels of syntactic and/or semantic granularity (e.g., project, file, file segments, statements . . . ). For example, type inference can be applied for local variables, fields or properties upon initialization, return values and/or parameter types.

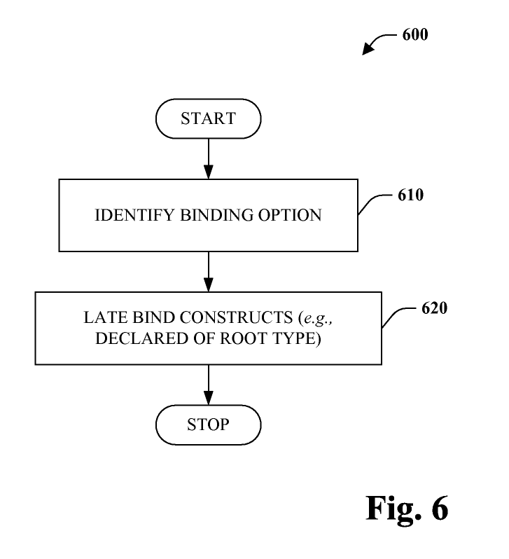

FIG. 6 depicts a binding method 600 in accordance with an aspect of the subject disclosure. Binding refers to binding types to objects at compile time or at runtime. Binding at compile time is advantageous in that it increases execution speed and reduces runtime errors. Alternatively, runtime binding provides programming flexibility, for instance where a compile type cannot be determined. At reference numeral 610, a binding option is identified indicating whether binding is early or late. This can be identified from project and/or file metadata. Additionally or alternatively, the binding option can be identified from a compiler command line prompt (e.g., “/optionstrict [+|−]”), among other things. At reference 620, late binding of constructs can occur. Late binding can comprise binding types to objects and/or objects to methods or the like. In accordance with one aspect, the binding can occur with respect to constructs explicitly declared of a root type such as “Object.” However, the scope of innovation need not be so limited.

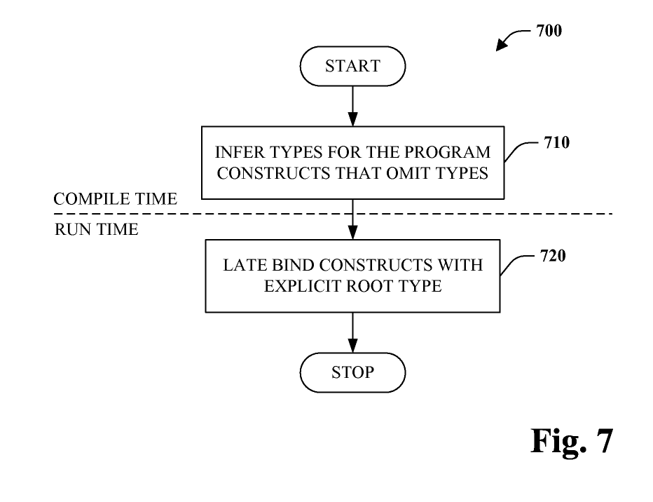

Referring to FIG. 7, a method of type inference and binding 700 is illustrated in accordance with an aspect of the claimed subject matter. It is to be appreciated that type inference and binding can be related and/or dependent upon each other. In other words, they can be employed together over a program in a single programming language. At reference numeral 710, type inference can be performed at compile time with respect to specified programmatic constructs that omit type. In other words, types can be early bound to constructs. For example, local variable types can be inferred and bound thereto upon initialization. At numeral 720, constructs not early bound are late bound. In accordance with an aspect of the disclosure, late bound constructs can be uniquely identified, for instance via explicit specification of a root type such as object or special static type (e.g., dynamic), among other things. For example, type parameters can be bound to types and/or method bound to objects, among other things.

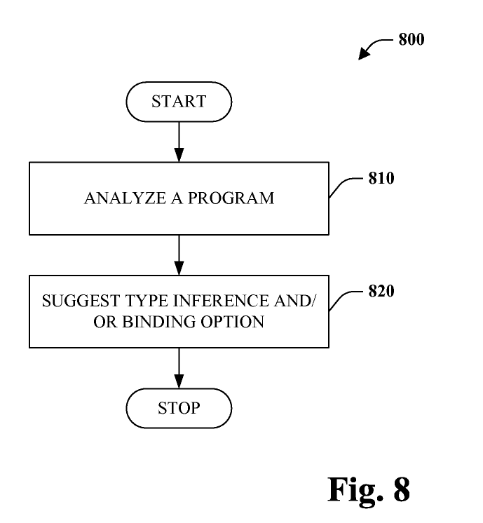

FIG. 8 is a flow chart diagram of a method of provisioning programmatic assistance 800 in accordance with an aspect of the claimed subject matter. At reference numeral 810, a program is analyzed. For example, control flow and/or data flow analysis can be employed to analyze program specification. At reference numeral 820, suggestions, recommendations or hints can be provided with respect to type inference and/or binding options. Based on particulars of program specification such suggestions or the like can be made with a view toward minimizing errors. For instance, if turning type inference on would produce less errors that when it is off, then a program can be notified that he might like to turn type inference on. Similarly, if a late bound program would produce fewer errors, then a late bound option can be recommended. These suggestions can be provided at a program, file and/or construct level. In one instance, a warning can be displayed alone or in combination with a smart tag which would allow a use to toggle options in accordance with a suggestion (e.g., option infer on/off, option strict on/off).

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

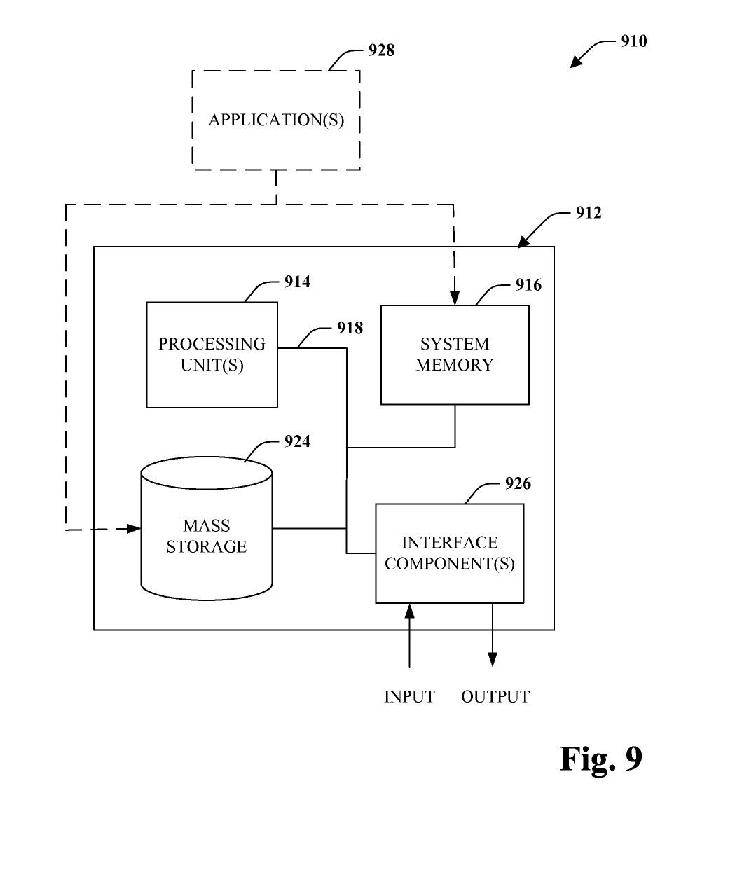

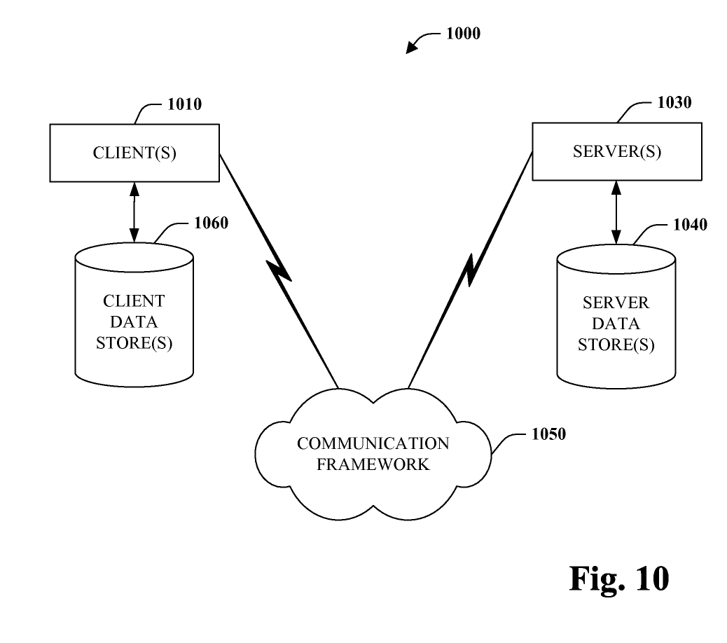

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 9, an exemplary environment 910 for implementing various aspects disclosed herein includes a computer 912 (e.g., desktop, laptop, server, hand held, programmable consumer or industrial electronics . . . ). The computer 912 includes a processing unit 914, a system memory 916 and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory or memory stick. In addition, mass storage 924 can include storage media separately or in combination with other storage media.

FIG. 9 provides software application(s) 928 that act as an intermediary between users and/or other computers and the basic computer resources described in suitable operating environment 910. Such software application(s) 928 include one or both of system and application software. System software can include an operating system, which can be stored on mass storage 924, that acts to control and allocate resources of the computer system 912. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., CRT, LCD, plasma . . . ), speakers, printers and other computers, among other things.

FIG. 10 is a schematic block diagram of a sample-computing environment 1000 with which the subject innovation can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

For example, programs can be specified with type inference and/or binding options and compiled on a client 1010. Subsequently, the compiled program can be provided to one or more servers 1010 for distribution over communication framework 1050 to multiple clients 1010. Recipient clients can subsequently perform late binding at runtime. Similarly, functionality associated with suggesting and/or determining options can be embodied in a plug-in, which can be downloaded from a server 1030 to a client 1010 for installation and use.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A program compilation system, comprising:
an identifier component that identifies compiler options including an inference option associated with a computer program; and
an inference component that infers types as a function of the inference option.

2. The system of claim 1, the inference option is associated with a project and/or file.

3. The system of claim 1, the inference option identifies one or more applicable syntactic and/or semantic constructs on which the option applies.

4. The system of claim 3, the syntactic and/or semantic constructs are local variables, fields, or properties, result types and/or method parameters.

5. The system of claim 1, the inference option identifies one or more syntactic and/or semantic constructs on which the option is does not apply.

6. The system of claim 1, the identifier component identifies a binding option.

7. The system of claim 6, further comprising a binding component that binds types to objects in accordance with the binding option.

8. The system of claim 7, the inference option and binding option are dependent upon one another.

9. The system of claim 7, the binding component performs late binding when a language root type or special static type is explicitly specified.

10. The system of claim 1, the options are specified in a compiler command line statement.

11. A method of program translation, comprising:
identifying inference and binding options for a program;
inferring types for programmatic constructs that omit a type if the inference option is on; and
delaying binding of types to objects until runtime for programmatic constructs annotated with a root type if the binding option is on.

12. The method of claim 11, identifying the options from within the program and/or at compiler command line.

13. The method of claim 11, further comprising producing an error if a type is omitted for a programmatic construct and the inference option is off.

14. The method of claim 11, further comprising inferring types for a local variable, field or property, return value and/or a method parameter.

15. The method of claim 11, further comprising binding types to objects at compile time if the binding option is off.

16. The method of claim 11, further comprising identifying the inference option as a function of the binding option or identifying the binding option as a function of the inference option.

17. A computer readable medium having stored thereon a computer program comprising:
a plurality of computer programming code; and
an option statement within the code that indicates whether or not type inference is to be performed with respect to the code.

18. The computer readable medium of claim 17, the option statement identifies syntactic constructs on which type inference is on or off.

19. The computer readable medium of claim 18, the option statement identifies local variables, fields, or properties, return types and/or method parameters.

20. The computer readable medium of claim 17, further comprising an option statement identifies whether or not late binding is applicable.
